(19) United States
(12) Patent Application Publication
(10) Pub. No.: US 2002/0023527 A1
(43) Pub. Date: Feb. 28, 2002

(54) Apparatus to guide and stabilize the blade of a band saw

(76) Inventor: Larry Wood, Wyalosing, PA (US)

Correspondence Address: GOTTLIEB RACKMAN & REISMAN PC, 270 MADISON AVENUE, 8TH FLOOR, NEW YORK, NY, 100160601

(21) Appl. No.: 09/833,984

(22) Filed: Apr. 12, 2001

Related U.S. Application Data
(60) Provisional application No. 60/196,682, filed on Apr. 12, 2000.

(51) Int. Cl. B26D 5/00

(52) U.S. Cl. 83/821; 83/788

(57) ABSTRACT

A guide for the blade of a band saw providing support for the rear edge and sides of the blade. The guide utilizes two cylindrical rings or anvils that may be adjusted to contact the sides of the blade. A rotating spool within the anvils provides the support for the rear edge of the blade. The spool may be easily adjusted to provide support for blades of varying depth. The entire guide may be mounted on the guide arm of most band saw blades and pivoted into position through the use of an adjustable saddle.

### FIELD OF THE INVENTION

This invention relates to band saws. More specifically, the invention involves a guide for the blade of a band saw for stabilizing and aligning the blade while an object is being cut by the blade.

### BACKGROUND OF THE INVENTION

Anyone having performed any work on a band saw readily understands the difficulties involved due to the nature of the saw. The blade of the band saw is generally flexible. This flexibility allows the blade to ride in a repetitively circular manner around wheels driven by a motor through a cutting zone on the saw. However, the flexible nature of the blade also lends itself to undesirable movement. While pushing an object for cutting through the cutting zone, the blade may shift horizontally or twist as a result of the force against the blade exerted by the object being cut. This shifting or twisting may result in a loss of precision for purposes of the intended cut as the angle of the blade changes. Additionally, the force exerted on the blade may also negatively affect the alignment of the blade on the wheels of the saw.

Prior art devices have attempted to stabilize blade movement with some success. For example, in the patent to Duginske et al. (U.S. Pat. No. 4,920,846), fiber guide blocks mounted on the sides of the blades have been used to restrict side-to-side movement. However, these devices are of limited usefulness because of the great friction caused when the blade contacts the blocks.

One improvement to these blocks is taught in the patent to Foley (U.S. Pat. No. 3,145,604). In Foley, a guide is provided with a set of angled wheels that rotate as the blade passes between the wheels. While the guide provides protection from horizontal movement, due to the angled nature of the wheels it is generally complex to adjust to maintain proper alignment of the blade in the cutting zone. Moreover, this angling reduces support by reducing contact area. Additionally, the wheels provide no mechanism for adjustment for blades of different sizes. Thus, the potential surface area of the support of the wheels against the blade remains constant. As larger blades are used, less support is provided.

In another implementation of wheels, the patent to Karubian (U.S. Pat. No. 4,141,142) teaches the use of a guide with two side wheels each rotating in the same direction as the blade with their axes of rotation being parallel to the depth (front edge to the back edge) of the blade and perpendicular to the length of the blade in the cutting zone. An additional back wheel with an axis of rotation perpendicular to the depth and length of the blade also supports the blade. The devices generally eliminate the friction on the blade. Thus, as some friction is desirable to scour or clean the blade, this device has limited usefulness. Moreover, due to the curvature of the wheel approaching the blade, debris from a cutting operation on the saw may serve to chock or jam rotation of the wheels. This will result in unsatisfactory performance of the band saw.

### BRIEF DESCRIPTION OF THE INVENTION

An objective of the present invention is to provide an easy to use adjustable guide for band saws.

Another objective of the present invention is to provide a guide that provides thorough support against twisting and horizontal movement.

A further objective of the present invention is to provide such support while reducing friction to minimize blade and guide wear.

A still further objective of the present invention is to provide a guide to prevent jamming caused by debris from the band saw.

Additional objectives will be apparent from the description of the invention as contained herein.

In its broadest aspect, the present invention involves a band saw guide with two opposing rotating cylindrical rings or anvils. The anvils rotate parallel with the sides of the saw blades to provide for maximal surface contact. Thus, the anvils provide lateral support for the blade of a band saw to prevent the blade from lateral movement and undesired twisting. The anvils also scour and clear debris from the blade. These rings or anvils are mounted to bearings and installed within an adjustable guide head.

In addition, the band saw guide combines rearward support for the blade using a rotating spool supported within the cylindrical anvils. In a preferred embodiment, the rotating spool has multiple steps. With the steps and a means for adjusting the spool, the guide may be easily used with blades of different depths.

The guide is also designed for easy installation on many different band saws. Through the use of a pivoting saddle and a yoke, the guide may be mounted to an existing guide arm of most band saws. The guide head then may be pivoted into position behind the blade through an adjustment on the saddle.

### BRIEF DESCRIPTION OF THE DRAWINGS

FIG. 1 depicts one type of band saw using a guide of the present invention;

FIG. 2 depicts an exploded view of an embodiment of the band saw guide of the present invention showing the components thereof;

FIG. 3 is a top-down view of an embodiment of the band saw guide with a cross-section of the guide head taken along line 3-3 of FIG. 1, but illustrating the use of a large blade;

FIG. 4 is a side view of an embodiment of the band saw guide of FIG. 3 with a cross-section of the yoke and guide head taken along line 4-4 of FIG. 3;

FIG. 5 is a top-down view of an embodiment of the band saw guide with a cross-section of the guide head taken along line 3-3 of FIG. 1, but illustrating the use of a small blade;

FIG. 6 is a side view of an embodiment of the band saw guide of FIG. 5 with a cross-section of the yoke and guide head taken along line 5-5 of FIG. 5.

### DETAILED DESCRIPTION OF THE INVENTION

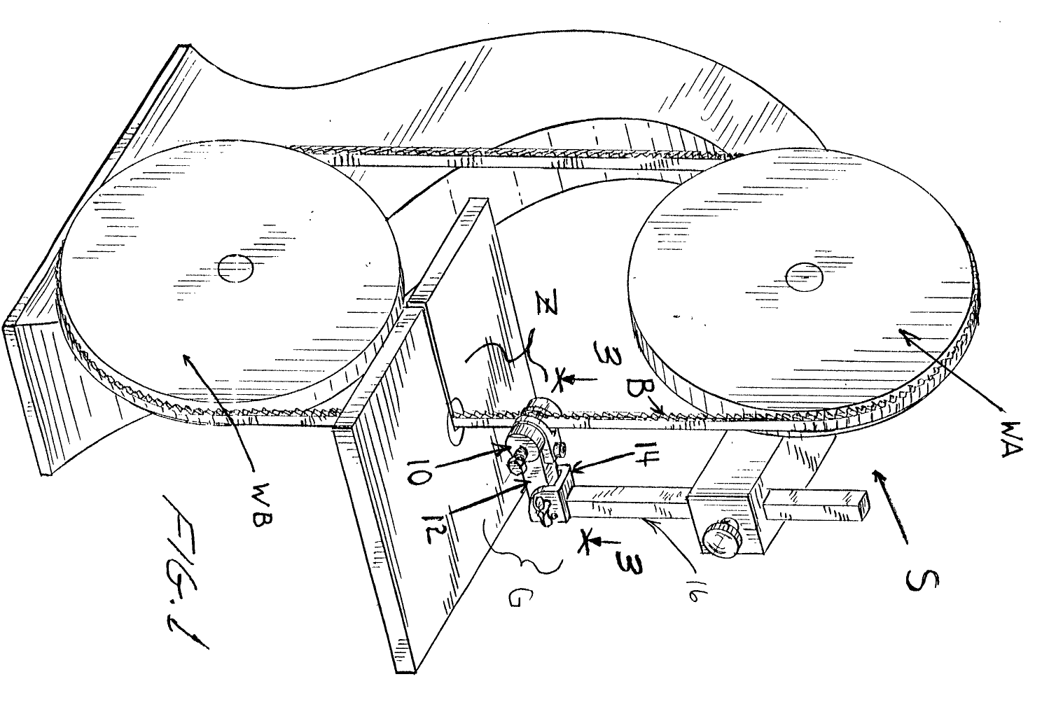

A band saw guide G of the present invention installed on a band saw S is illustrated in FIG. 1. The guide G mounts to a band saw S in the region of the cutting zone Z. The guide G is made from three parts including a guide head 10, a yoke 12 and a saddle 14. Generally, the guide head 10 serves as a housing for the adjustment and stabilization components used for guiding the blade B. The yoke 12 serves the purpose of securing the guide head 10. The saddle 14 is used to attach the yoke 12 to a guide arm or bar 16 mounted on the band saw S behind the path of the blade B.

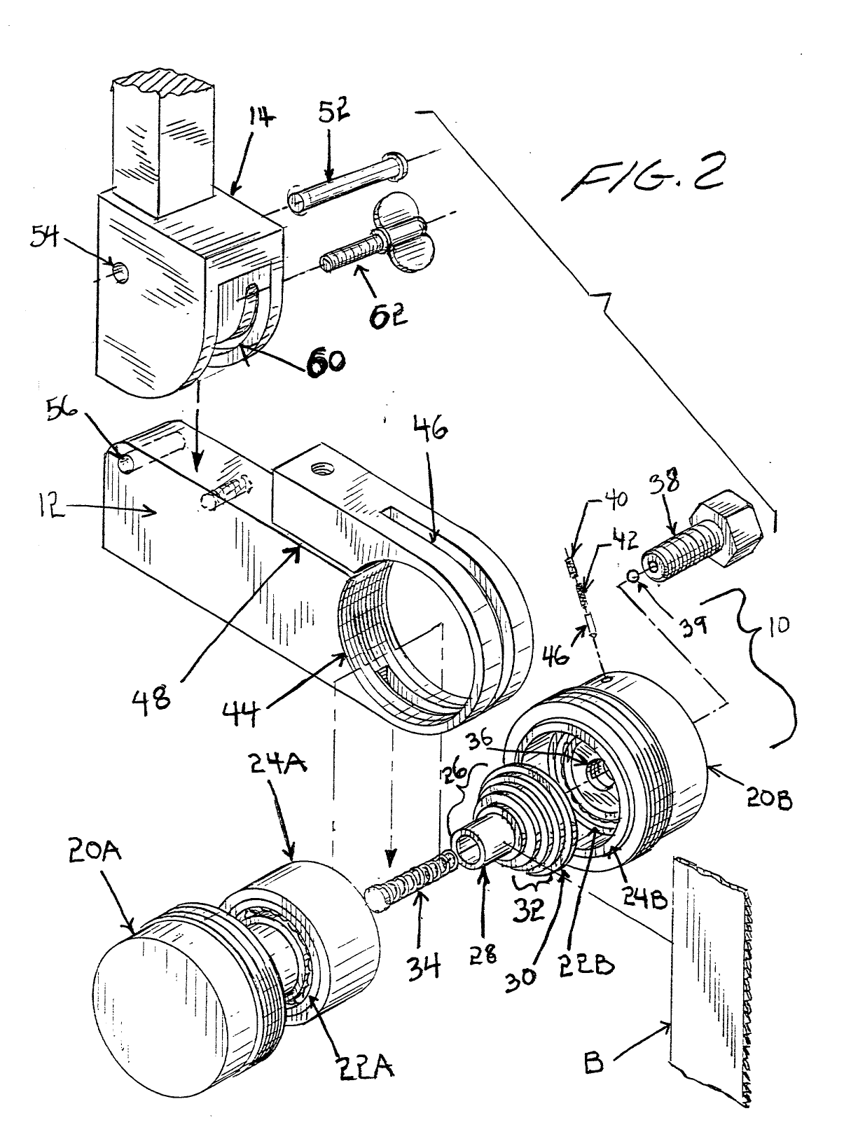

FIG. 2 illustrates the components of the guide head 10. The guide head 10 has a proximal threaded head member 20A and distal threaded head member 20B. Each head member 20A and 20B contains a rotating bearing 22A, 22B. A cylindrical ring or anvil 24A, 24B is press fitted to each rotating bearing 22. The outer circular surfaces of the edge of the anvils 24A, 24B are parallel to the surfaces of the sides of the blade B to maximize contact with the blade B and thus minimize twisting or lateral movement. Since the anvils will be in contact with the sides of the blade B during operation, the anvils 24A, 24B are preferably made from hardened steel. Optionally, the outer edges of the anvils may be extended or enlarged to increase the surface area that comes in contact with the blade B during operation.

Residing within the head members 20A and 20B is a blade spool 26, which will be in contact with the rear edge of the blade B in operation. In one embodiment of the invention, the blade spool 26 is simply made from a cylinder post 28 and circular disk 30 only (not shown). The circumference of the disk 30 is sized to fit within the cavity of the distal anvil 24B. An aperture within the proximal head member 20A is sized to receive the cylinder post 28. A washer 29 in the aperture provides the bearing support for the cylinder post 28 while allowing the cylinder post 28 to rotate. In this embodiment of the spool 26, no adjustment for blades of different depths is provided.

In an alternative embodiment of the invention, the spool 26, in addition to the cylinder post 28 and circular disk 30, has one or more circular steps 32, each with a different radius. Thus, each step 32 provides a different level for the rear edge of blades of different depths. In this embodiment, a spring 34 extends from within the cylinder post 28 to the proximal head member 20A, which may contact it by a ball bearing. The disk 30 may slide laterally or axially within the distal anvil 24B. An adjustment aperture 36 in the distal anvil 24B receives a spool adjustment member 38 to contact the disk 30 at a ball bearing.

The preferred spool adjustment member 38 is associatively gauged with the spool 26 to allow metered adjustment from one step 32 to another. To this end, the thread width of a threaded spool adjustment member 38 may be coordinated with the width of the steps 32, each having a common width, so that a single turn of the threaded spool adjustment member 38 will allow the spool 26 to move from one step to the next. In this embodiment, the threaded spool adjustment member 38 has a slot along its shaft. A pin 46 with a curved tip contained by a threaded stop 40 and pin spring 42 engages the shaft and slot of the adjustment member. As the adjustment member 38 is turned, the slot and pin allow for visual and tactile feedback with each turn while changing from one step to the next.

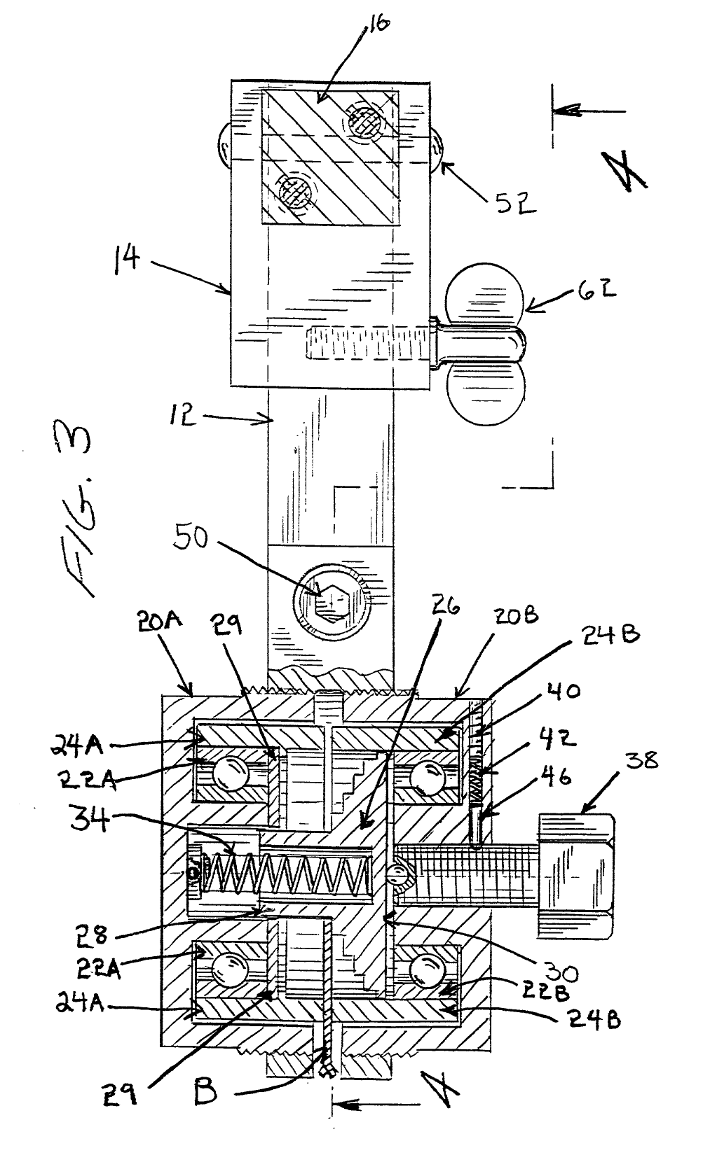

Continuing with FIG. 2, the yoke 12 has of a guide head aperture 44. The aperture 44 is threaded to receive the head members 20A, 20B. A blade slot 46 through a portion of the aperture 44 is provided to allow the blade to pass through the yoke 12. A gap 48 in the yoke 12 allows the yoke 12 to be tightened down around the head members 20A, 20B using a threaded adjustor 50 (shown in FIGS. 3-6) in the top portion of the yoke 12 to restrict turning or adjustment of the head members 20A, 20B.

The saddle 14 is connected with the yoke 12 on a pivot pin 52 through pivot holes 54 and 56. The angle of the yoke 12 around the pivot pin 52 is adjusted with pivot adjustment 62 through slot 60. Thus, the yoke 12 with guide head 10 may be pivoted toward the blade or away from the blade as desired. As an alternative embodiment, the saddle 14 may act as a sleeve to receive the yoke 12 without a pivot pin 52. In this embodiment (not shown), the yoke 12 may slide laterally in the saddle 14 to allow the guide head 10 to be moved away from or near to the blade B for saw or other blade adjustment purposes. An adjustment mechanism, such as a threaded fastener, is used to restrict or allow the lateral movement of the yoke 12 in the saddle 14 when desired.

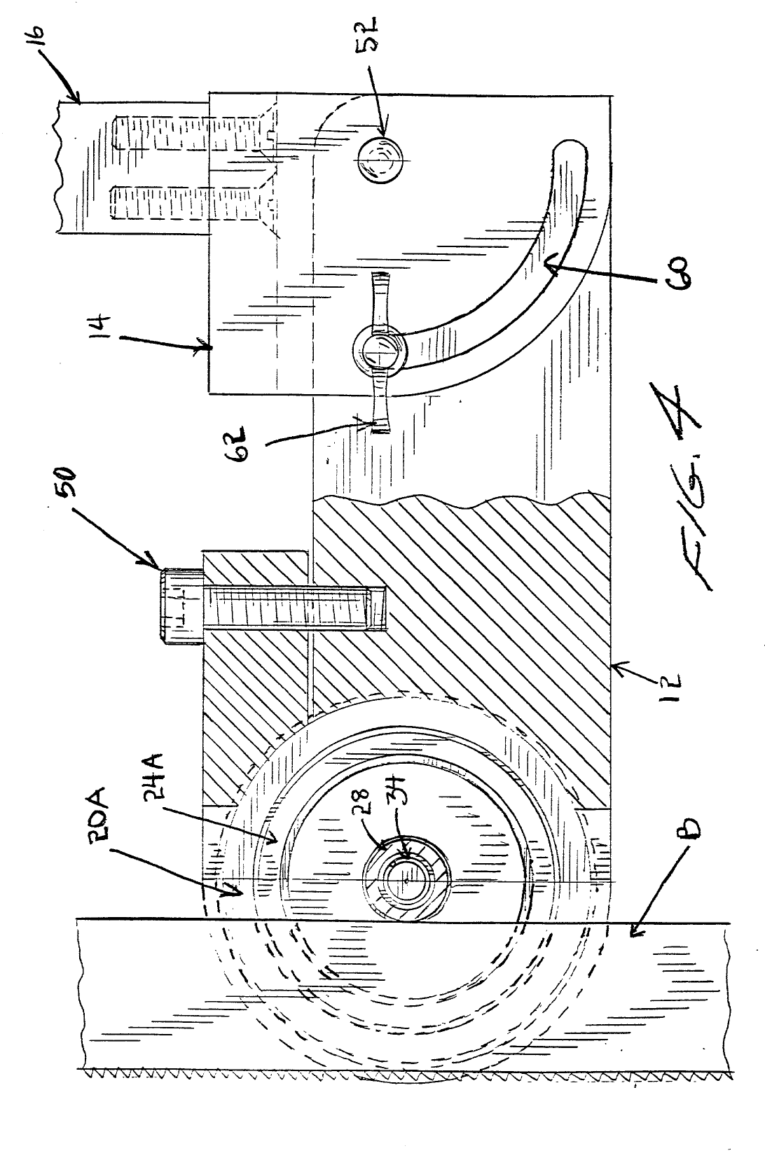

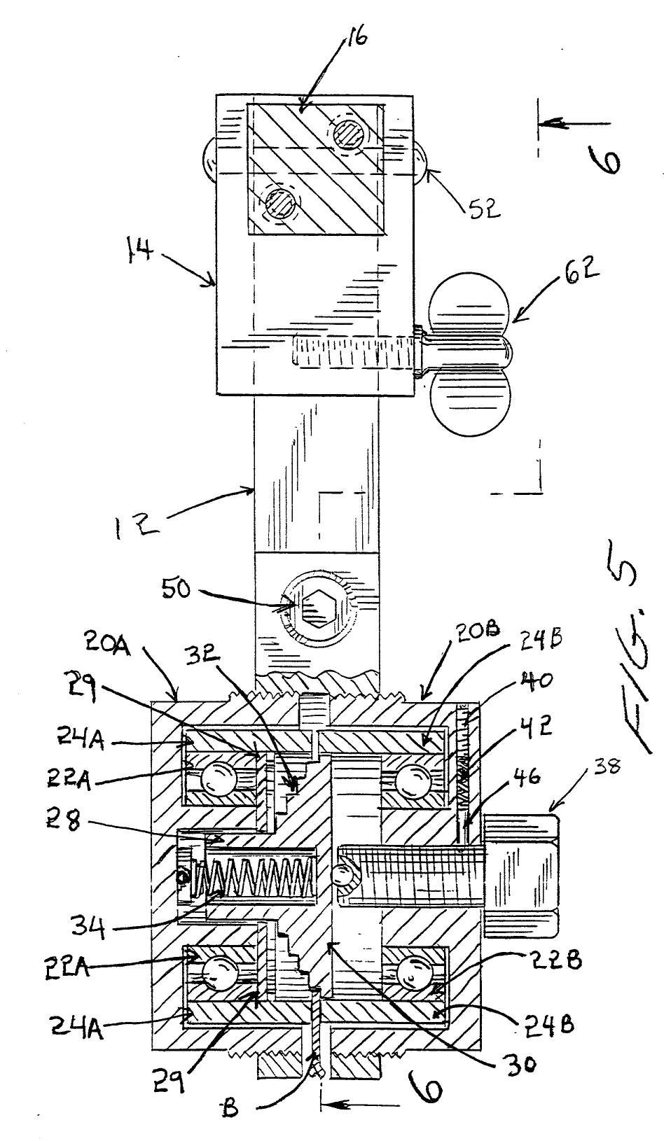

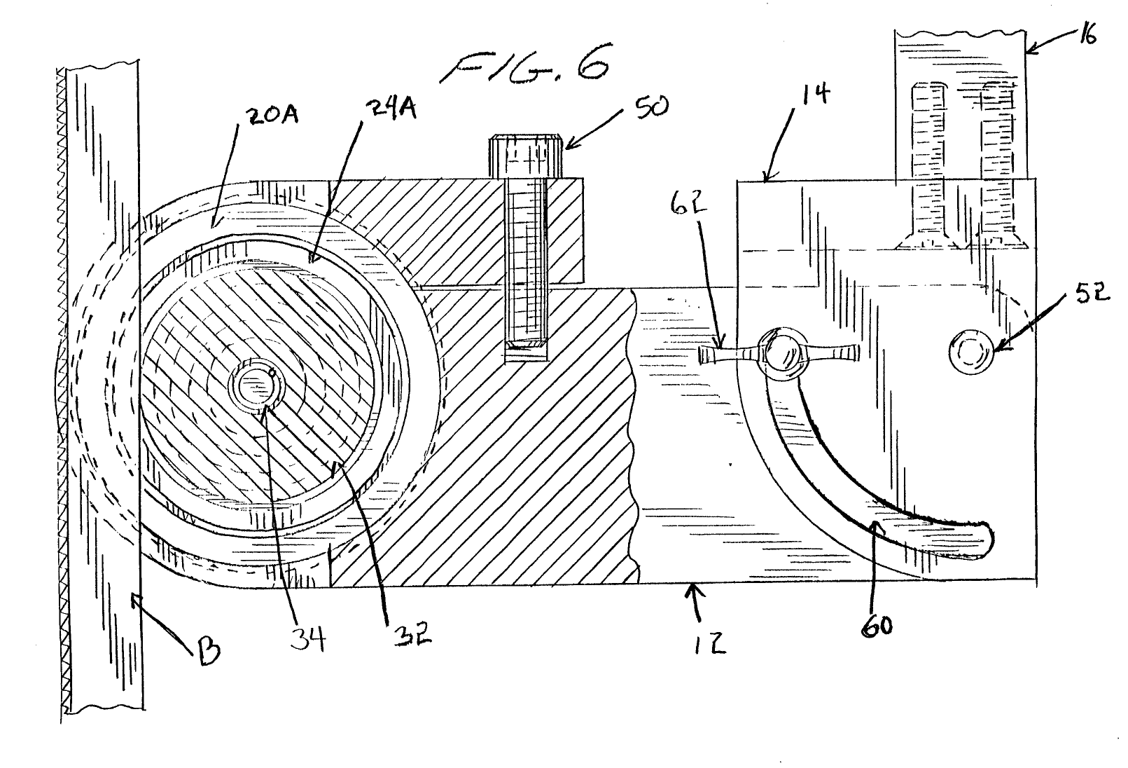

The benefits of this apparatus, if not immediately apparent from the foregoing description of components, will be clearer by examining FIGS. 3 through 6 in conjunction with a description of the guide in use. More specifically, FIGS. 3 and 4 show the installation of a large blade and FIGS. 5 and 6 show the installation of a small blade. With the saddle 14 mounted to the guide bar 16, the proximate and distal anvils 24A, 24B are adjusted to create a space or gap for a blade between them by rotating the head members 20A, 20B counter-clockwise. The blade spool 26 may be adjusted to select an appropriate step 32 on the spool such that the maximum area of the blade B, excluding the blade teeth, may be within the guide head between the anvils 24A, 24B. Thus, for the large blade of FIGS. 3 and 4, the spool adjustment member 38 is rotated counter-clockwise to allow the spool 26 to slide laterally so that a portion of the cylinder post 28 is aligned with the distal anvil 24B. For a small blade, the spool adjustment member 38 is rotated clockwise to allow the spool 26 to slide laterally or axially so that the step 32 with the largest radius is aligned with the distal anvil 24B. Alternatively, other steps 32 may be selected.

The combined guide head 10 and yoke 12 may, after the adjustments as describe above, then be pivoted into position behind the blade by adjusting the pivot adjustment 62 such that the rear edge of the blade B will rest against the spool 26 through blade slot 46 of the yoke 12. Then, head members 20A and 20B may be rotated clockwise such that the proximal and distal anvils 24A, 24B tighten or clamp against the sides of the blade B. In addition, since both head members 20A, 20B may be rotateably adjusted towards the sides of the blade B, the head members 20A, 20B can be aligned laterally to keep the blade B perfectly vertical within the guide G relative to the cutting zone Z and the peripheral edge of the wheels WA, WB of the band saw S. Once head members 20A, 20B are tightened, the top portion of the yoke 12 may be tightened down to prevent movement of the head members during band saw operations using a threaded fastener 50 in the yoke. This tightening effectively reduces the circumference of the guide head aperture 44, thereby restricting movement of the head members.

In operation, due to the presence of the bearings 22A, 22B, the anvils 24A, 24B will rotate within the head members 20A, 20B as the blade B trains through the cutting zone Z following the path of the wheels WA, WB. Similarly, the spool 26 will rotate. The axis of rotation of the anvils 24A, 24B and the spool 26 will be perpendicular to the length of the blade and perpendicular to the depth of the blade. This rotation is caused by the contact of the blade B against the anvils 24A, 24B and the spool 26. Thus, the blade B will be subjected to rotational friction by the anvils 24A, 24B as they move across the blade depth and down or up the blade length.

This rotational action has several benefits. Since the spool 26 and the anvils 24A, 24B rotate, friction against the blade is minimized when compared with stationary block type guides. Although some wear will occur, since the entire edge of each anvil will rotate to contact the blade surface, the anvils 24A, 24B will wear evenly reducing the need for anvil maintenance. In addition, the friction that is created results in the scouring of the sides of the blade while slewing saw debris away from the guide to avoid jamming.

In the preferred embodiment, all of the adjustments required by the guide G may be performed by hand, without tools.

Although the invention has been described with reference to particular embodiments, it is to be understood that these embodiments are merely illustrative of an application of the principles of the invention. Numerous modifications, in addition to the illustrative embodiments of the invention discussed herein may be made and other arrangements may be devised without departing from the spirit and scope of the invention.

1. A guide for the blade of a band saw comprising:
a pair of rotateable cylindrical rings with opposing parallel contact surface edges;
a guide head to contain said rings;
a rotateable spool to contained within said rings adjacent to the rear edge of said blade; and
a yoke to receive said guide head; said guide head being adjustable on said yoke to cause said rings to embrace the sides of said blade between said opposing contact surface edges.

2. The guide of claim 1 wherein said yoke has an tightening member to restrict the adjustment of said guide head.

3. The guide of claim 1 further comprising a saddle, wherein said band saw has an arm connected to it and said saddle is attached to said arm and said yoke connects to said saddle.

4. The guide of claim 3 wherein said saddle includes a pivot and adjustment mechanism to allow said yoke to pivot towards and away from said blade.

5. The guide of claim 3 wherein said saddle is a sleeve with an adjustment mechanism to allow said yoke to move laterally within said saddle.

6. The guide of claim 1 wherein said spool has steps of different radii to support the back of blades of different depths.

7. The guide of claim 5 further comprising a spool adjustment device in contact with said spool to align one of said steps on said spool with one of said contact surface edges.

8. The guide of claim 7 wherein said spool adjustment device is associatively gauged with said spool.

9. The guide of claim 8 further comprising a contact pin wherein said spool adjustment device has threads with a longitudinal slot to receive said pin and a turn of said spool adjustment device selects an adjacent step of said steps.

10. The guide of claim 7 wherein said spool adjustment device causes said spool to slide laterally.

11. The guide of claim 8 further comprising a spring adjacent to said spool.

12. A guide for the blade of a band saw comprising:
a saddle configured to attach to said band saw;
a yoke attached to said saddle;
a guide head attached to said yoke;
two anvils each attached to a rotating bearing within said guide head; and
a rotateable spool to support a rear edge of said blade within said guide head;
wherein said anvils are adjustable to contact the sides of said blade and said anvils rotate on an axis of rotation that is perpendicular to both the depth and length of the blade in a cutting zone.

13. The guide of claim 12 wherein the rotation of said guide head results in the anvils being adjusted to contact the sides of the blades.

14. The guide of claim 13 wherein said yoke has a tightening member to restrict the rotation of said guide head

15. The guide of claim 14 wherein said saddle has a pivot member to allow said yoke and said guide head to pivot towards and away from a position adjacent to said blade.

16. The guide of claim 14 wherein said saddle is a sleeve with an adjustment mechanism to allow said yoke to move laterally within said saddle.

17. The guide of claim 12 wherein said spool is adjustable to accomodate blades of different depth.

18. The guide of claim 17 wherein said spool has steps of varying diameters.

19. The guide of claim 18 further comprising a metered adjustment member in contact with said spool wherein said spool is adjusted to select one of said steps by said adjustment member.

20. The guide of claim 19 wherein said adjustment member is threaded through said guide head.

21. A guide for the blade of a band saw comprising:
a spool to provide rearward support for said blade;
two cylindrical rings to rotate on an axis of rotation perpendicular to both the depth and length of said blades in a cutting zone of said band saw;
means for adjusting said rings against the sides of said blade; and
means for attaching said spool and said rings to a band saw.

22. The guide of claim 21 further comprising means for adjusting said spool wherein said spool has steps for blades of different depth.
